(19) United States
(12) Patent Application Publication
(10) Pub. No.: US 2010/0198804 A1
(43) Pub. Date: Aug. 5, 2010

(54) SECURITY MANAGEMENT FOR DATA VIRTUALIZATION SYSTEM

(75) Inventors: Steven Yaskin, Marlboro, NJ (US); Andrei Zudin, Moscow (RU)

Correspondence Address: FENWICK & WEST LLP, SILICON VALLEY CENTER, 801 CALIFORNIA STREET, MOUNTAIN VIEW, CA, 94041, US

(73) Assignee: QUEPLIX CORP., Princeton, NJ (US)

(21) Appl. No.: 12/699,264

(22) Filed: Feb. 3, 2010

Related U.S. Application Data
(60) Provisional application No. 61/149,966, filed on Feb. 4, 2009.

(51) Int. Cl. G06F 17/30

(52) U.S. Cl. 707/706; 707/770; 707/E17.032; 707/E17.005; 707/785; 707/E17.108

(57) ABSTRACT

Methods and systems allow access to information in an enterprise environment that stores information in data silos. Entity type metadata, relations between entity types and access control information is extracted from the data silos and represented in a data virtualization system. Metadata information representing security information extracted from multiple data silos is combined to construct global security information for the enterprise. Security roles are combined to generate global security roles and access control lists are combined to generate globalized access control lists. The global security information can be modified by system administrators. Security information is refreshed from the data silos for each session created by the user and is applied to all data access requests created using the session.

### CROSS REFERENCE TO RELATED APPLICATIONS

This application claims the benefit of and priority to, U.S. Provisional Application No. 61/149,966, filed Feb. 4, 2009, the contents of which are incorporated by reference in its entirety.

### BACKGROUND

1. Field of Art

The disclosure relates to security management for searches across information in an enterprise that stores information in data sources across organizational silos.

2. Description of the Related Art

Information in an enterprise, for example, corporation, non-profit organization, or government entity, often exists in data silos that are populated by systems or applications that may or may not interact with each other. Information is often represented as data entities in data silos. Often, entities represented electronically correspond to real world entities. For example, a data entity may represent the information for an employee of the enterprise. Data entities existing in different data silos may describe the same real world entity. Often, entities stored in one data silo may be related to entities stored in a different data silo. Security constraints related to entities can exist in one or more silos. For example, access to information about an entity may be restricted to certain users, based on their roles and permissions. The security constraints existing in two data silos for the same real world entity may overlap in some aspects and differ in other aspects.

Accessing information in the world of an enterprise for processing is different from accessing information on the internet or on an individual's desktop. Among many factors that make information access in an enterprise unique are: (1) Information is behind the firewall and is usually not accessible from the outside world but must be accessible to company employees based on security constraints of the enterprise. (2) Information is available in different data silos that usually do not interact or share information with each other and related information may have differing security constraints in different data silos. (3) Most information is stored in the form of structured data in databases, as opposed to individual searches where most information is stored in the form of unstructured data, for example, documents, pictures, HTML (HyperText Markup Language) and XML (Extensible Markup Language) files. As a result, a system that allows global access to information in an enterprise faces very different challenges compared to a system that allows access to information on the internet or on an individual's desktop.

### SUMMARY

The above and other issues are addressed by a computer-implemented method, computer system, and computer program product for managing security for data access and searches across an enterprise comprising a plurality of data silos. Embodiments of the method comprise receiving a request associated with a user for creating a session for retrieving information stored in the data silos. Security information associated with the user from a data silo is retrieved responsive to receiving the request for creating the session. A search request associated with the session is received for searching information across the data silos. A set of electronic documents matching the search request are retrieved from a plurality of electronic documents. The electronic documents belonging to the plurality of electronic documents represent instances of entity types in the data silos. A subset of the set of electronic documents corresponding to documents representing entity types that the user is permitted to access based on the security information is returned.

Embodiments of the computer system for searching across an enterprise comprising a plurality of data silos comprise a computer processor and a computer-readable storage medium storing computer program modules. The computer program modules comprise a web server and a search engine module. The web server is configured to receive a request associated with a user for creating a session for retrieving information stored in a plurality of data silos. Security information associated with the user is retrieved from a data silo responsive to receiving the request for creating the session. The search engine is configured to receive a search request associated with the session for searching information across the plurality of data silos. The search engine retrieves a set of electronic documents matching the search request from a plurality of electronic documents. The electronic documents belonging to the plurality of electronic documents represent instances of entity types in the data silos. The search engine returns a subset of the set of electronic documents corresponding to documents representing entity types that the user is permitted to access based on the security information.

Embodiments of the computer program product for searching across an enterprise comprising a plurality of data silos have a computer-readable storage medium storing computer-executable code for searching across an enterprise. The computer-executable code comprises a web server and a search engine module. The web server is configured to receive a request associated with a user for creating a session for retrieving information stored in a plurality of data silos. Security information associated with the user is retrieved from a data silo responsive to receiving the request for creating the session. The search engine is configured to receive a search request associated with the session for searching information across the plurality of data silos. The search engine retrieves a set of electronic documents matching the search request from a plurality of electronic documents. The electronic documents belonging to the plurality of electronic documents represent instances of entity types in the data silos. The search engine returns a subset of the set of electronic documents corresponding to documents representing entity types that the user is permitted to access based on the security information.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a high-level diagram illustrating the overall approach towards the security management for a data virtualization system in accordance with an embodiment of the present invention.

FIG. 2 shows one embodiment of the architecture of a computer device that may be used to execute modules of the system in FIG. 1.

FIG. 3 illustrates the architecture of a data virtualization system for allowing access to information in an enterprise, for example, via search in accordance with an embodiment of the present invention.

FIG. 4 illustrates the various security objects that can be defined in the data virtualization system in accordance with an embodiment of the present invention.

FIG. 5 illustrates relations between various security objects and entity types in accordance with an embodiment of the present invention.

FIG. 6 shows a flowchart describing the process for extracting information including security information from multiple data silos and representing it in a format that allows access to the enterprise information, for example, via search in accordance with an embodiment of the present invention.

FIG. 7 illustrates how merging relations between global entity types results in an enterprise wide data model in accordance with an embodiment of the present invention.

FIG. 8 illustrates how security information is combined in a data virtualization system to generate globalized security constraints in accordance with an embodiment of the present invention.

FIG. 9 shows a flowchart describing the process for enforcing security constraints for a user session that allows access to the enterprise information, for example, via search in accordance with an embodiment of the present invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

Information in an enterprise is available in multiple data silos and includes large amount of structured data that may be stored in relational databases along with unstructured data. In an enterprise, the data silos may correspond to different applications that may not interact with each other. A data virtualization system provides capability to access information from multiple structured and unstructured data sources across multiple data silos. In one embodiment, the data virtualization system allows users to access information via search queries. Data access in the data virtualization system enforces global security constraints based on a combination of security information available in the multiple data silos of the enterprise. A user is allowed to see the results and portions of the resulting entities that the user is allowed to access in the enterprise. A user is not allowed to see the results or portions of the entities that the user does not have access in the enterprise.

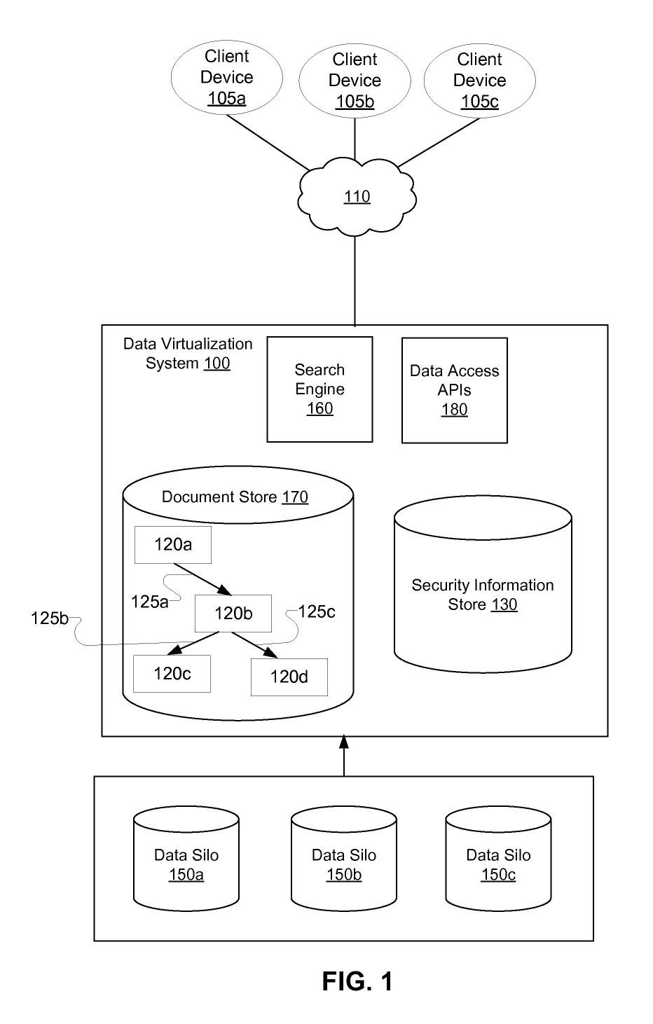

FIG. 1 presents the overall approach towards a data virtualization system 100. Users can access information in the data virtualization system 100. For example, users can access information available in the data virtualization system 100 by using applications that use the data access application programming interface (API) 180 to access the information over the network 110. The data access APIs 180 allow an external application to access information in the data virtualization system 100 subject to the security constraints defined in the data virtualization system 100 and stored in the underlying data silos 150 in accordance with an embodiment of the present invention. For example, a business intelligence (BI) tool can access the data virtualization system to provide analytical reports based on information available across various data silos 150. Examples of BI tools that can access data available in a data virtualization system include tools provided by vendors including BUSINESSOBJECTS, COGNOS, and ORACLE. Structured data as well as unstructured data is virtualized and exposed by the data access APIs 180. As a result the data schema that is presented to an external application, for example, the BI tools, encompasses the structured data as well as unstructured data, thereby providing access to the unstructured data as if it was structured. An example application written using the virtualized data schema includes an application that utilizes structured data available in a database as well as unstructured data available in an email server. Alternatively, users can access information by conducting enterprise searches over the search engine 160 using client devices 105 communicating with the integrated enterprise search system 100 over the network 110.

FIG. 1 and the other figures use like reference numerals to identify like elements. A letter after a reference numeral, such as “150(a)” or “150a” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120a” and/or “120b” in the figures).

Information stored in selected data silos 150 of an enterprise is used as input to build a representation of all the information stored in chosen data silos 150 in the enterprise. In one embodiment, the representation of the information extracted from the data silos 150 is stored as a virtual website. Information including records stored in relational databases, objects, documents and the like are represented as documents 120 representing entities that are linked to each other. The term document refers to an electronic document that can be processed by a computer. For example, documents 120 can be HTML web pages linked to each other via standard HTML links. A document 120 can have a link 125 to another document 120 even though the two documents represent entities from separate data silos, for example, 150(a) and 150(b). If a document 120 is based on an instance of entity represented in multiple data silos, the document 120 may include information from multiple data silos, for example, data silos 150(a) and 150(b). The web pages of the virtual website can be indexed and made searchable using a search engine 160.

The security information store 130 stores security information extracted from the data silos as well as any security information that can be added to the data virtualization system 100. Security information added to data virtualization system 100 includes security information manually added by a system administrator or imported from other systems, for example, global identity management systems as described herein. The search engine 160 uses the information in security information store 130 to determine the information that can be accessed by a user, for example, search results that can be returned to a user in response to a search query. A document may match the search criteria for a query from the user and may be ranked high based on its relevancy score but the document may not be presented to the user if the search engine 160 determines that the user is not allowed to access the document based on security constraints specified in the security information store 130.

If an enterprise user accesses information via searches, the relevancy of search results is different for an enterprise user from the relevancy of search results in an internet search or desktop search. For example, relevancy of search results in an enterprise search can be based on factors including, the role of the user, frequency of entity transactions, or last transaction time. Entities in an enterprise may have transactions associated with them. An enterprise search should be capable of presenting the updated entity based on the latest transactions in real-time. Furthermore applying security constraints to search results requires combining access control information from multiple data silos and must be enforced in real-time. Changes to access control information in the data silos must be reflected in the data virtualization system 100 in real-time. For example, a user who moves from one role in the enterprise to another may be disallowed access based on his previous role. It may be unacceptable in an enterprise to reflect these changes after a long time, for example a couple of days, thereby continuing to allow the user to access information based on his previous role and not enabling access based on the user's current role. To enable the enterprise to function smoothly, the changes to security information in an enterprise must be reflected in real-time in the data virtualization system, thereby keeping the real world entity changes synchronized with the virtual representations of the entities in the data virtualization system.

In an embodiment, a real world object and its associated processes are abstracted as entity types. For example, a customer and the various interactions possible with a customer can be represented using a “customer” entity type. Similar to real world entities, entity types can be linked to each other, consist of several attributes, change their state and execute certain actions. For example, an entity type can be defined to encapsulate an object representing a “support engineer” or a “customer enquiry.” The entity type representing a “support engineer” can have attributes including, first and last names, position, and supervisor. Similarly, the entity type representing a “customer enquiry” can have attributes including enquiry time, status, and the customer requesting the enquiry. The two entity types can be related to each other, for example the “customer enquiry” may have a “support engineer” working on the enquiry to resolve it.

The state of the entities can also change over time, for example, the working hours of the “support engineer” can change, and the status of the “customer enquiry” can change when it is resolved. Entities can execute associated actions, for example, if a “customer enquiry” is resolved, the information regarding the resolution may be published in a knowledge base. An entity instance refers to a particular instance of an entity type, for example, Joe and Bob may be two support engineers and a distinct entity instance of the entity type “support engineer” may represent each support engineer.

Different data silos within an organization may contain the same entity with data that is common across different silos as well as data that is specific to each silo. Similarly security constraints associated with the entities may be applicable across silos or be specific to the silos. An instance of an entity in the data virtualization system 100 combines the relevant information available across data silos appropriately so as to appear as one unified entity rather than disparate representations of the same entity. In an embodiment, if the security information present in two different silos contradicts each other, the access permission is applied on an entity field level and allowed access right prevails over denied access rights. For example, if data access to an entity field is allowed in one data silo and denied in another data silo, the access to the entity field is allowed to the user. In an enterprise, specific information may be accessible only to certain users, based on their roles and permissions. Security constraints may be associated with entity types or with fields of entity types. For example, a set of users may be allowed access to all the data available in an entity type. On the other hand, a set of users may be allowed access to only specific fields of an entity type. For example, all users in an enterprise may have access to the first name, last name, and work phone numbers of all employees in the enterprise but only the users belonging to the human resources department may be allowed access to the salary field of the employee entity. In an embodiment, the security constraints may be specific to instances of an entity types. Accordingly, different instances of an entity type may be associated with different security constraints. The security constraints are enforced whenever a user accessed information from the enterprise. For example, search results presented to a user invoking a search contain only entities that the user is allowed to access in the enterprise. Besides, an entity included in the search results includes only attributes that the user is allowed to access.

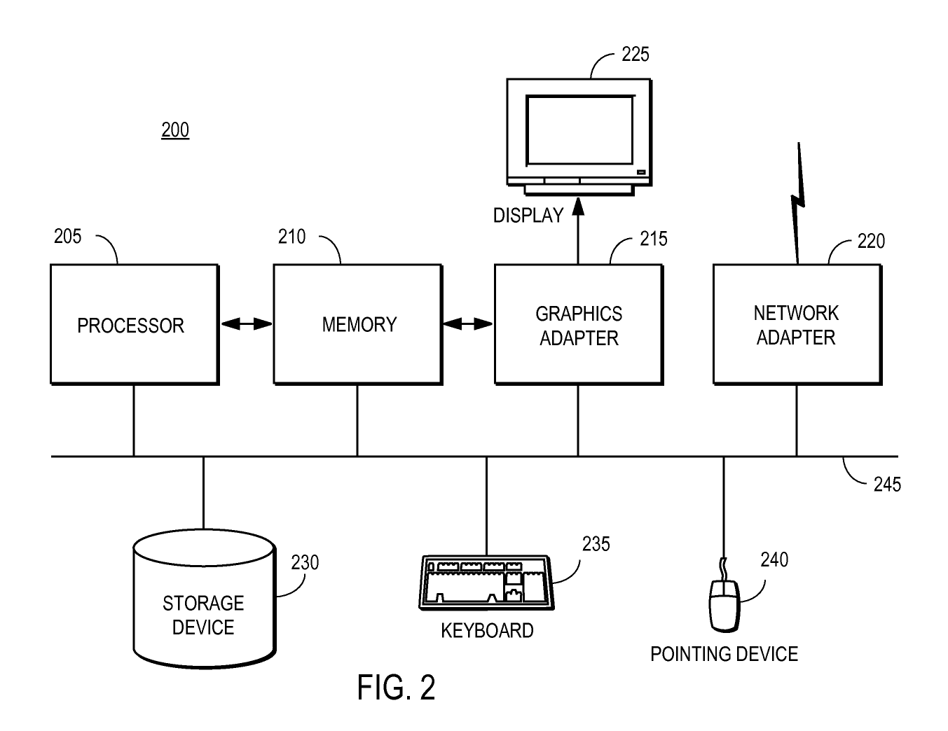

Next, FIG. 2 is a high-level block diagram illustrating a functional view of a typical computer 200 for executing the various modules required for the integrated enterprise search system. Illustrated are at least one processor 205 coupled to a bus 245. Also coupled to the bus 245 are a memory 210, a storage device 230, a keyboard 235, a graphics adapter 215, a pointing device 240, and a network adapter 220. A display 225 is coupled to the graphics adapter 215.

The processor 205 may be any general-purpose processor such as an INTEL compatible-CPU (central processing unit). The storage device 230 is, in one embodiment, a hard disk drive but can also be any other device capable of storing data, such as a writeable compact disk (CD) or DVD, or a solid-state memory device. The memory 210 may be, for example, firmware, read-only memory (ROM), non-volatile random access memory (NVRAM), and/or RAM, and holds instructions and data used by the processor 205. The pointing device 240 may be a mouse, track ball, or other type of computer (interface) pointing device, and is used in combination with the keyboard 235 to input data into the computer system 200. The graphics adapter 215 displays images and other information on the display 225. The network adapter 220 couples the computer 200 to the network.

As is known in the art, the computer 200 is adapted to execute computer program modules. As used herein, the term “module” refers to computer program logic and/or data for providing the specified functionality. A module can be implemented in hardware, firmware, and/or software. In one embodiment for software and/or firmware, the modules are stored as instructions on the storage device 230, loaded into the memory 210, and executed by the processor 205.

The types of computers 200 utilized can vary depending upon the embodiment and the processing power required in the context. For example, a client device 105 typically requires less processing power than a server used to run a search engine. Thus, the client device 105 can be a standard personal computer system. The server, in contrast, may comprise more powerful computers and/or multiple computers working together (e.g., clusters or server farms) to provide the functionality described herein. Likewise, the computers 200 can lack some of the components described above. For example, a computer 200 may lack a pointing device, and a computer acting as a server may lack a keyboard and display.

### System Architecture

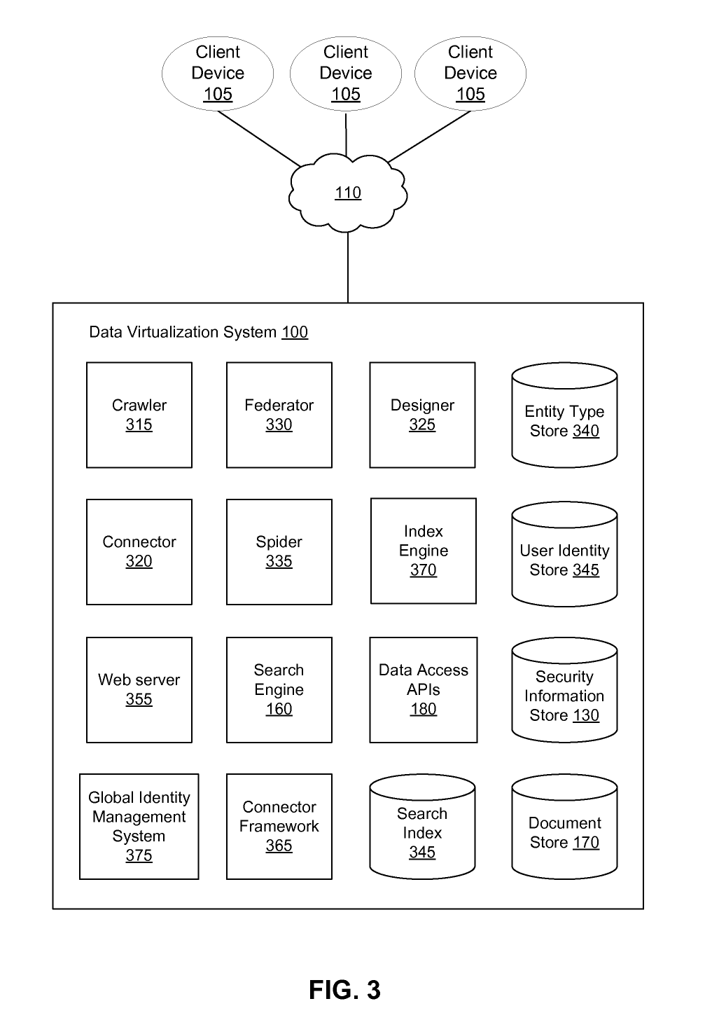

FIG. 3 is a high-level block diagram illustrating a system for allowing users to access enterprise information made available via a data virtualization system 100. The system environment comprises one or more client devices 105, a network 110, and a data virtualization system 100. In alternative configurations, different and/or additional modules can be included in the system.

The client devices 105 comprise one or more computing devices that can receive member input and can transmit and receive data via the network 110. For example, the client devices 105 may be desktop computers, laptop computers, smart phones, personal digital assistants (PDAs), or any other device including computing functionality and data communication capabilities. The client devices 105 are configured to communicate via network 110, which may comprise any combination of local area and/or wide area networks, using both wired and wireless communication systems.

The a data virtualization system 100 comprises a computing system that takes data available in various data silos 150 of an enterprise as input and converts it to a format that allows an enterprise user to access information of the enterprise, for example, by executing searches. The a data virtualization system 100 includes a crawler 315, one or more connectors 320, a federator 330, a spider 335, a designer 325, a web server 355, a search engine 160, an index engine 370, a connector framework 365, data access APIs 180, a global identity management system 375, an entity type store 340, a document store 170, a user identity store 345, a security information store 130, and a search index 345. In other embodiments, the data virtualization system 100 may include additional, fewer, or different modules for various applications. Conventional components such as network interfaces, load balancers, failover servers, management and network operations consoles, and the like are not shown so as to not obscure the details of the system.

The crawler 315 is responsible for initial discovery and extraction of business entity types and relationships between entity types across various data silos 150 in the enterprise. There can be an entity type relationship between two entity types if the corresponding data model in the data silos specifies a relationship, for example, a foreign key relationship between entity types. If there is an entity type relationship between two entity types, there can be an entity instance relationship between instances of the two entity types if the specific instances are related. The connector 320 module allows the crawler 315 to connect to third party applications to discover entity types in the data stored in the applications. There may be different connectors 320 for connecting to different applications in the enterprise. The connector framework 365 allows the crawler 315 to execute logic provided as connectors for discovering metadata from the data silos 150. The designer 325 provides a visual interface to allow an administrator (an administrator refers to any privileged user allowed to perform specialized tasks, for example, tasks related to system configuration) to control the discovery and extraction of the crawler 315. The designer 325 also allows an administrator or business analyst to maintain the information extracted and modify the extracted information if needed. The federator 330 takes the entity types extracted by the crawler 315 and recognizes common entity types across all the entities discovered across the various data silos 150 and merges them appropriately to create global entity types as well as global security information associated with entity types. The raw entity types as well as the global entity types discovered are stored in the entity type store 340. The global identity management system 375 provides authentication for users and can be, for example, a single sign-on system or a light weight directory access protocol (LDAP) system. The access control information extracted from the data silos as well as additional access control information extracted from other sources including the global identity management system 375 is stored in the security information store 130. The information describing users of the data virtualization system 100 that is extracted from the data silos or from the global identity management system 375 is stored in the user identity store 345. The federator 330 also processes the data in the data silos 150 to generate HTML documents for the discovered entity instances that are stored in the document store 170. The documents in the document store 170 are indexed by the index engine 370 to create a search index 345. The web server 355 receives incoming requests from the client devices 105 and forwards the requests to the search engine 160. Applications can process information available in the data virtualization system 100 using the data access APIs 180. The data access API 180 provides the metadata representation of the aggregated data from the various data silos. The metadata represents the structured data as well as unstructured data in the enterprise. The search engine 160 processes the incoming search requests and returns the search results to the requestor. The spider 335 is an ongoing process that queries various data silos for changed information and feeds the changes to the federator 330 which are ultimately fed to the index engine 370 and to the search engine 160. The overall process based on one embodiment of the method used by integrated search system is described below, followed by the detailed description of the various modules.

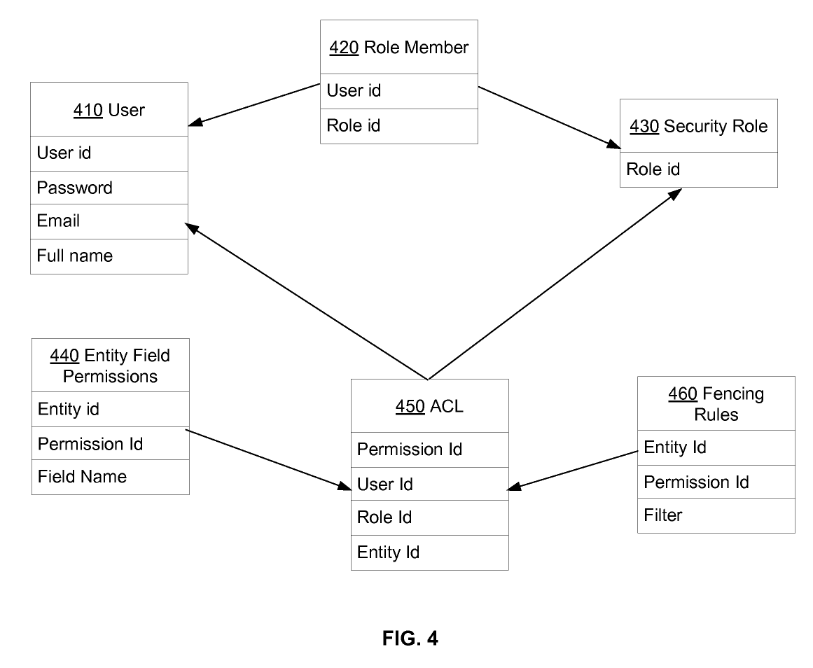

FIG. 4 shows the details of security objects defined in the data virtualization system 100. The various security objects illustrated in FIG. 4 include users 410, security roles 430, role members 420, access control lists (ACLs) 450, entity field permissions 440, and fencing rules 460.

A user 410 has login information that allows the user to be authenticated for access to information in the data virtualization system 100. It is assumed that login name is unique for user in the scope of external data silo. The source of the user information, for example, the data silo from where the information is extracted is stored in the user identity store 345 for each user and silo combination. Both login and source will uniquely identify a user; the data virtualization system 100 defines this as user id. Besides these two elements additional three optional fields are available to store user specific information: password, email and full name.

Security roles 430 (also called workgroups) are primarily used to group different users to allow effective security management. Some data silos correspond to systems that do not have a concept of security role; in those systems ACL information is associated directly with users 410. Security roles 430 have a name and source identifying where the security role/workgroup 430 is managed. The combination of name and source uniquely identifies a security role 430 and this pair is called a role id. Role member objects 420 provide cross reference between users and roles. Each role member 420 object has a user id and role id.

Access control lists (ACL) 450 link entities, entity fields and corresponding data filters with users or roles. The ACL 450 metadata is very simplified—if a user 410 or a security role 430 is defined in the security information store 130 and an entity or entity field is identified as accessible for this user 410 or security role 430, the corresponding entity or a field data can be retrieved by the user 410 or a user with the security role 430. For example, the corresponding entity or field data can appear in search results shown to the user 410 or a user with the security role 430. Each ACL 450 record is identified by the source where it is managed and a name (in many cases auto generated). The ACL 450 record links a user or security role with a reference to the entity id for which it defines data access permission.

ACLs can be used to extend security information stored in external data sources (for example, data silos 150). In one embodiment, the ACL 450 records are stored in the security information store 130 while the links to users/roles and entities point to external systems.

Entity field permissions 440 are cross-references between entity fields and ACLs. Entity field permissions 440 may be created as follows: if some entity is accessible to a user or security role and there are no entity field permissions 440 defined for this entity then all attributes of this entity are accessible to the corresponding user/security role. Otherwise, only entity fields explicitly defined in the entity field permissions 440 are accessible to the user/security role and those not defined are not accessible.

Similar to entity field permissions 440, cross-reference fencing rules 460 specify “horizontal filters” for entity data. For example, fencing rules 460 can be created to further limit certain values within entity fields to be permitted.

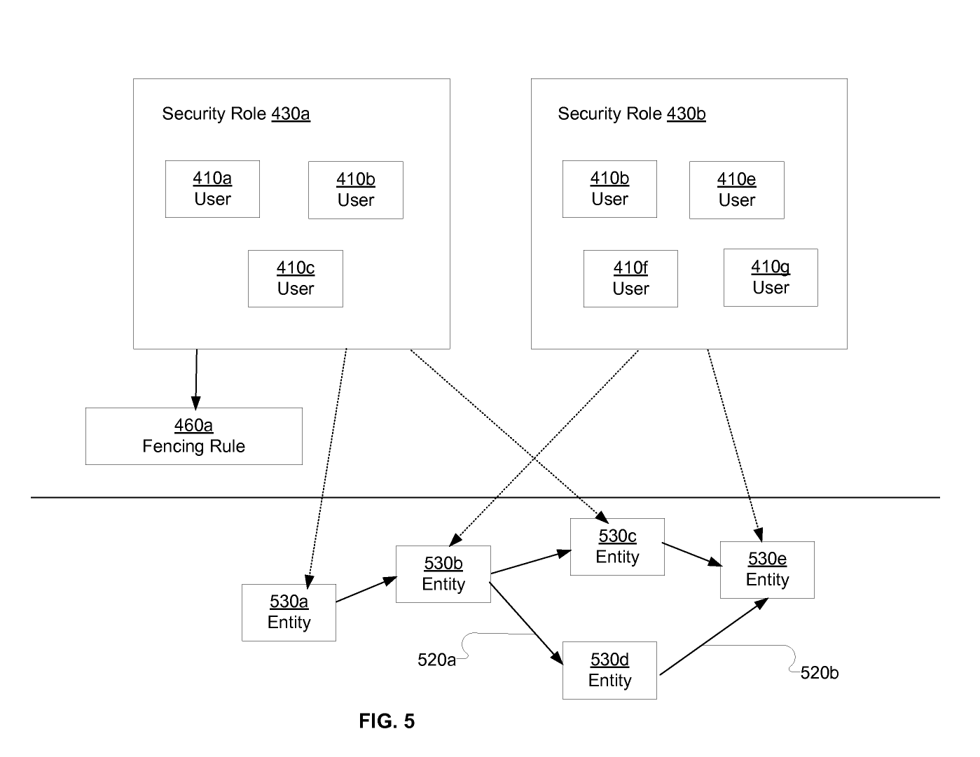

FIG. 5 illustrates the relationship between security roles 430, fencing rules 460, users 410, and entities 530. Each security role 430 is associated with a set of users 410. Alternatively, each user 410 has an associated security role 420. For example, security role 430a is associated with users 410a, 410b, and 410c and security role 430b, is associated with users 410b, 410e, 410f and 410g. An entity can belong to multiple security roles, for example, entity 410b belongs to both security role 430a and 430b. The entity information extracted from the data silos 150 are represented as a graph of entity types 530 connected by edges representing entity type relationships 520.

Security role 420 consists of a list of permissions for entity types and if needed down to entity fields. Each security role 430 can be considered associated with a set of entity types 530 that are accessible to users belonging to the security role 430. For example, the security role 430a is associated with entity types 530a and 530c, and security role 430b is associated with entity types 530b and 530e. Each user 410 belonging to the security role 430 is granted access to each entity associated with the security role. For example, users 410a, 410b, and 410c have access to entity types 530a and 530c. User 410b has access to entity types 530a and 530c as well as entity types 530b and 530e since user 410b belongs to both security roles 430a and 430b.

Security administration screens of the designer 325 allow a system administrator to see the up-to-date security information. For example, if user U has security role R and access to a list of objects (O1, O2, . . . , On) in the external data silo (e.g. a SAP system) this information will be displayed through designer's 325 search administration screens. Since this information is managed by the external application it may appear as “read-only” to the system administrator. In this case, the system administrator is not allowed to modify security information extracted from the external silo—this needs to be done in the external application. In one embodiment, the system administrator sees all users and corresponding security roles from all data silos in the same interface he or she may give access to user from data silo S1 to entities extracted from data silo S2. The system administrator is able to do so by creating a new virtual security role that exists in the data virtualization system 100 and keeps associations of users and entities from various data silos. These permissions are maintained by the system administrator.

The crawler 315 module extracts user, user groups/security roles and ACL information from various data silos; however, if security metadata cannot be effectively extracted for some type of an application and no plug-in connector exists then the corresponding security metadata can be created in designer 325 by the system administrator. This information is refreshed in real time before it is used (e.g. during user authentication/authorization or when it must be changed).

If an entity type is associated with a security role 410, then that security role allows searching for instances of the entity type. Security roles 410 can be associated with filters or fencing rules 460 defined by administrators beforehand. Entity filters or fencing rules 460 specify the “horizontal” permissions for entity data. For example, a fencing rule may specify access to an entity type for customers of Canada only or solutions for specified product only. If some fencing rule 460 is associated with a security role 430 it means that specified role allows searching for entities filtered out by the rule only.

During the user authorization process the system builds an effective list of permissions for the user 410. An effective list of permissions can be a simple list of entity names possibly with field restrictions and filters the user 410 can see. When returning the search results for the user 410, the search engine 160 discards results that do not match the effective permissions of the user 410. Similarly, if an external application sends a request using the data access APIs 180 on behalf of a user, entities not matching the effective permissions for the user are not returned.

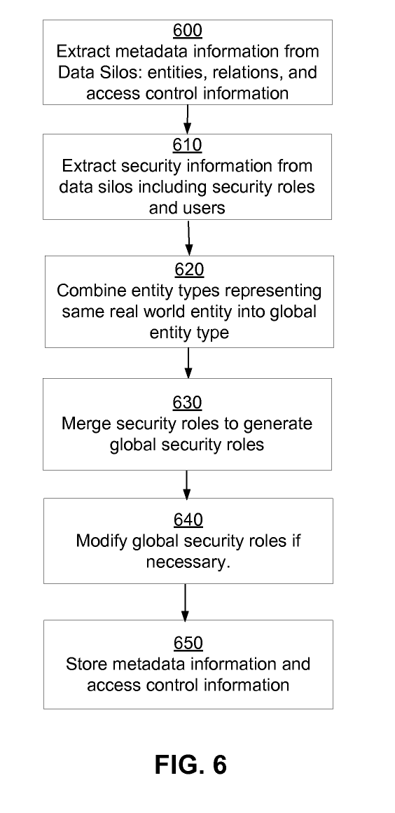

FIG. 6 shows a flowchart describing an embodiment of the process for extracting information from multiple data silos and representing it in a format that allows secure access to the information. Metadata information is extracted 600 from data silos in an enterprise by the crawler 315. The information extracted includes different kind of information available in the data silos including entity types, relations between entity types, actions associated with entity types, and access control or security information associated with entity types. Furthermore, security information including security roles and user identities are extracted 610 from the data silos. The user information is stored in the user identity store 345 and the security roles are stored in the security information store 130.

An administrator can verify the discovered information using the designer 325 and make modifications if needed. In general, the modifications are allowed if they are consistent with the data model. Entity types that represent the same real world entity but are obtained from different data silos are combined 620 by the federator to generate a global entity type that encapsulates the real world entity and stores the information available in the different representations of the entity type. If two or more entity types are combined into a global entity type, the related information associated with the entity type are also combined, for example, the attributes, actions, relations associated with the entity types. Security information is also combined to generate global security information, for example, security roles may be matched and merged 630 if possible to generate global security roles. The combined information can be verified by an administrator using the designer 325 and modified 640 if needed. The metadata generated by the crawler 315 and federator 330 is stored 650 in a suitable format, for example, XML document format. The metadata related to security can be stored in the security information store 130 or may be stored in the document store 170 as part of documents representing entity instances.

The metadata information collected by the crawler 315 and federator 330 can be used to discover the appropriate entity instances and their related information from the data silos of the enterprise. The associated information includes information for an entity instance, for example, related entity instances or access control information. The discovered entity instances are rendered as documents stored in document store 170. The format used for rendering entity instances is any suitable format that can represent the information associated with the entity instances including the relations between the entities, for example HTML format. The documents generated can be indexed by the index engine 370 so they can be searched by a search engine 160. The process of discovering new entity instances, rendering the discovered entity instances and their related information using documents, and indexing the document is repeated to incorporate changes in the information in the data silos over time. For example, the process can be repeated periodically to compute the relevant changes in the data silos since the last iteration of the process.

The crawler 315 maintains a metadata catalogue for storing the metadata of the discovered entity types in XML files including associated information including relations between entity types. The crawler 315 also discovers security information including predefined user accounts, security roles, and associated permissions. In one embodiment the crawler can extract the security information from a global identity management system 375, for example, a lightweight directory access protocol (LDAP) server. Alternatively, the crawler can use an application metadata connector (described below in detail) that encodes information related to the database schema including the tables that contain security information including users, roles, permissions etc. A user can also specify the database tables containing security information using the designer tool (described below in detail). In an embodiment, the crawler 315 extracts metadata related to entity types but does not extract entity instances. The information maintained by the crawler 315 in the metadata catalogue is available for other modules to use.

The entity type discovery performed by the crawler 315 can be based on analysis of database schema if a data silo stores information in relational database management systems. Alternatively the discovery can be based on application connectors if the data source is associated with an application. Even if the application stores its data in a relational database management system, the connector can provide additional information that makes the discovery efficient, leading to discovery of more or better information. If no special connector or additional information related to a data silo is available, the automatic discovery based on the schema of the relational database management system is used. The crawler 315 reads the data schema of each data silo's database including tables, views, primary and foreign keys, and additional constraints. The crawler 315 determines stand-alone entity types and identifies other entity types that can be linked to an entity type as attributes. By linking entity types with each other based on references between entity types, a hierarchy of entity types is created. A score is assigned to each entity type that is indicative of the relevance of an instance of the entity type that is presented to the viewer as part of search results. Entity types with higher score are considered more relevant to a user compared to entity types with lower score and are hence moved higher up in the order of search results.

Each table becomes an entity type with unique primary identifier determined either by primary key constraint or by analyzing table data. For example, if a table does not define a primary key, the various columns of the table can be examined to determine if one or more columns can be used to define a unique primary identifier. Foreign key constraints become relations between corresponding entities.

The crawler 315 can be provided with application connectors that include logic specific to an application that is useful for discovery of a more efficient and accurate entity type hierarchy and associated information. The connectors also help with discovery of security and access control information that is retrieved as part of the metadata discovery. A connector contains predefined metadata representing knowledge about the application of the database being crawled. The connector framework 365 allows a user to create a connector 320 as well as execute it. The connector framework 365 defines a set of APIs (Application Programming Interface) for connecting specific data silos to the integrated enterprise search system. Using these APIs, the quality of the metadata discovered can be improved since logic specific to a data schema or an application can be incorporated.

The connector framework 365 defines a set of application-level contracts between the integrated enterprise search system and connectors 320 to external systems. In addition to the extraction of metadata, the connector framework 365 is designed to extract user accounts and their corresponding permissions to search entities. The connector framework 365 also allows connecting to and reading from LDAP as well as applications, for example, SAP, SEIBEL, SALESFORCE.COM, etc.

Non-structured data silos are crawled by repository names based on the repository hierarchy. Typically the bottom-level containers become entity types and documents under these containers become entity instances. A bottom-level container is a hierarchical element of file storage: i.e. folder, data storage repository, LDAP container, etc. It is a logically grouped “collection” of documents.

The crawler 315 can be executed against multiple data silos. The metadata generated by the crawler 315 becomes the building block for the designer 325 to establish relations between entity types within the same or separate data silos and federator 330 to combine multiple entities into global entities. Besides the discovery of entity types, the crawler 315 also analyzes the best way to determine the last modification date of the data of the entity instances. For relational database data sources the last modification date or time may be available as fields that contain date or timestamp of transactions or data changes. For non-structured data repositories the last modification date or time can be determined by the last modified attribute in the repository metadata. The last modified date or time information is used to determine the data that changed since the last time the data was indexed.

The designer 325 is a visual interface to the crawler 315 that allows an administrator to establish connectivity to data silos of the enterprise and control the crawler 315 discovery and extraction process. The designer 325 also allows the administrator or a business analyst to maintain the extracted business entity types, user accounts, permissions, relations between entity types, relations between user and entity types and the like. The designer 325 provides graphical controls to enable modifying entity definitions in required and valid ways, for example, the designer 325 may not allow a user to create a new attribute for an entity type if the attribute does not exist anywhere in the underlying storage. The designer 325 allows modifications to the discovered metadata to better reflect real life information. For example, if there was no foreign key constraint between two tables in the underlying database schema and the crawler 315 failed to link the two entity types based on other mechanisms like connectors or preconfigured metadata dictionary the relation can be manually introduced with the help of the designer 325 if needed.

The federator 330 analyzes entity types extracted by the crawler 315 and possibly modified using the designer 325 to recognize common entities across all data silos crawled for the enterprise and merges them to create global entities. For example, a customer entity may exist in different data silos possibly associated with different applications. The federator 330 recognizes that the different customer entities defined in different data silos represent the same entity and creates a global customer entity type.

The federator 330 analyzes the metadata as well as data in the underlying database tables to determine if two entity types can be combined into a global entity type. The federator 330 uses semantic criteria to identify entity types for globalization or merging. It looks at the actual data in entity instances and compares such data for commonality. Within the data fields it can recognize unique identifiers, such as referential integrity external foreign keys, email addresses, social security numbers, LDAP user IDs, and semi-unique identifiers such as people's names, addresses, etc. For example, if two entity types extracted from two different data silos represent the same global entity type representing the same real world entity, individual entity instances have the same or similar values of identifying attributes. For example, if two data silos have entity types representing a customer, an individual instance of a customer in the two data silos has the same social security number, and the same representation of the name. Unique identifying strings are likely to have the exact same values across two different representations of an entity instance. Semi-unique attributes may have variations in the way they are represented, for example, name of a customer. One entity instance may represent the last name followed by the first name whereas another entity instance may represent first name followed by last name. However, the commonalities in the name representation can be detected by processing the name strings.

Based on commonalities of entity instances detected between entity types, the federator 330 determines whether to combine entity types into one globalized entity. If certain entity types are determined to be common across data silos, the entity types are combined by the federator 330 into global entity types. The metadata of the global entity type stores information related to the various entity types combined into the global entity type. An administrator can define different levels of tolerance in determining whether to combine entity types into global entity types. Stricter level of tolerance requires entity types to be determined to be combinable into global entity types only of unique identifiers match between entities, for example, matches based on social security numbers of employees. Relaxed levels of tolerance allow combining entity types if semi-unique identifiers are determined to be common between non-related entities, for example, customer name John and employee name John. The tolerance level can be specified for the whole enterprise or for specific entity types. When entity types are combined into global entity types, individual entity instances are combined into global entity instances. When two entity instances are combined into a global entity instance, the different attributes of the individual entity instances are merged to determine the attribute value of the global entity instance. Conflict resolution rules can be defined that allow attributes values of the global entity instances to be determined in cases where individual attributes of entity instances being combined fail to match.

The federator 330 extends the raw entity type metadata descriptors generated by the crawler 315 in order to produce global entity types. (1) The persistence storage definition of each entity type describing the source data silo of the entity type is extended with the list of storage definitions of merged individual entities. (2) The list of attributes of individual entity types is merged into the list of attributes of the global entity type. Certain attributes from different individual entity types are represented by a single attribute in the global entity type. If multiple attributes are merged into a single attribute in a global entity, conflict resolution rules are established to determine the value of the merged attribute in case the corresponding attribute values of individual entity instances do not match. Violations resolved using conflict resolution may be monitored by an administrator. Each global attribute metadata contains information describing its source data silos. Merged attributes refer to all the data silos containing the source entity types whereas single attributes based on a single entity type refers to a single data silo containing the source entity type. (3) List of relations of individual entity types are merged into a global list of relations, for example if the source entities can be combined and the target entities can be combined then the relations can be combined. Conflicts are resolved using conflict resolution rules that can be monitored. Merging of relations allows building an enterprise wide data model where information from various unrelated data silos can be linked to each other.

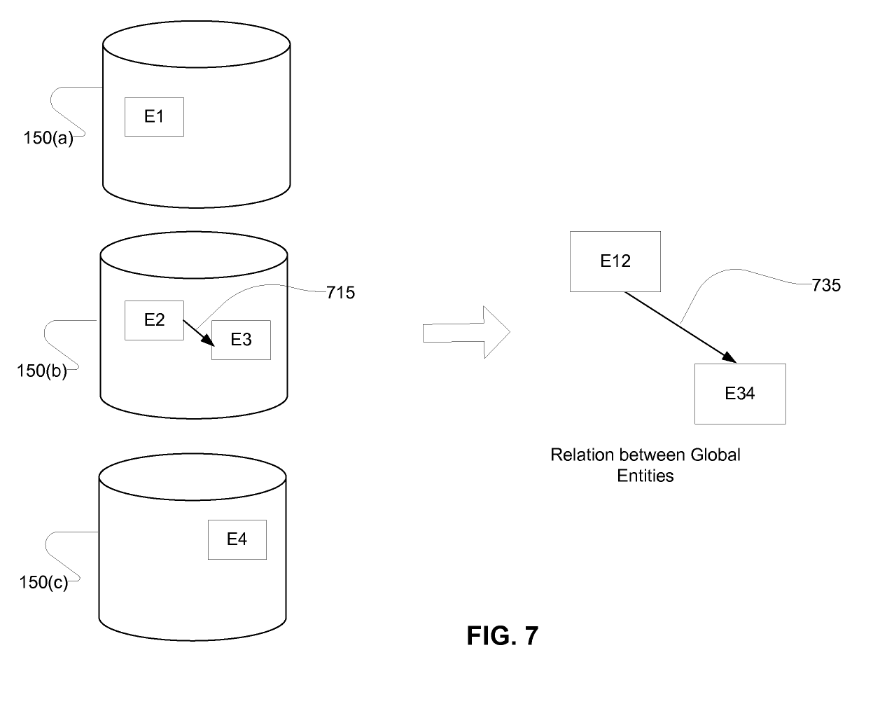

FIG. 7 shows an enterprise with three data silos 150(a), 150(b), and 150(c). Entity type E1 is discovered in data silo 150(a), entity types E2, E3 and a relation 715 between E2 and E3 is discovered in data silo 150(b), and entity type E4 is discovered in data silo 150(c). The federator 330 combines entity types E1 and E2 into a global entity E12 and combines entity type E3 and E4 into a global entity E34. The relation 735 between global entities E12 and E34 allows linking of entity types E1 and E4 that belong to different data silos with no relation between the underlying tables. Hence federator 330 creates a global data model linking data across the enterprise. For example, the entity type E1 may represent emails from an email application (for example, MS Exchange) that stored data in a silo, E4 may represent customer accounts in an accounting application that stores data in another silo, and the relation 715 may be obtained from a contact management module of a CRM (Customer Relationship Management) application that stores data in a third data silo. (4) Actions applicable to each individual entity are merged into the global entity's metadata. The enterprise application that is the action executor for each action can be determined based on the source data silo or application using the information stored in the metadata. (5) Lists of access permissions for each security role/user are merged. Field-level security is applied (a field refers to the storage definition corresponding to an attribute).

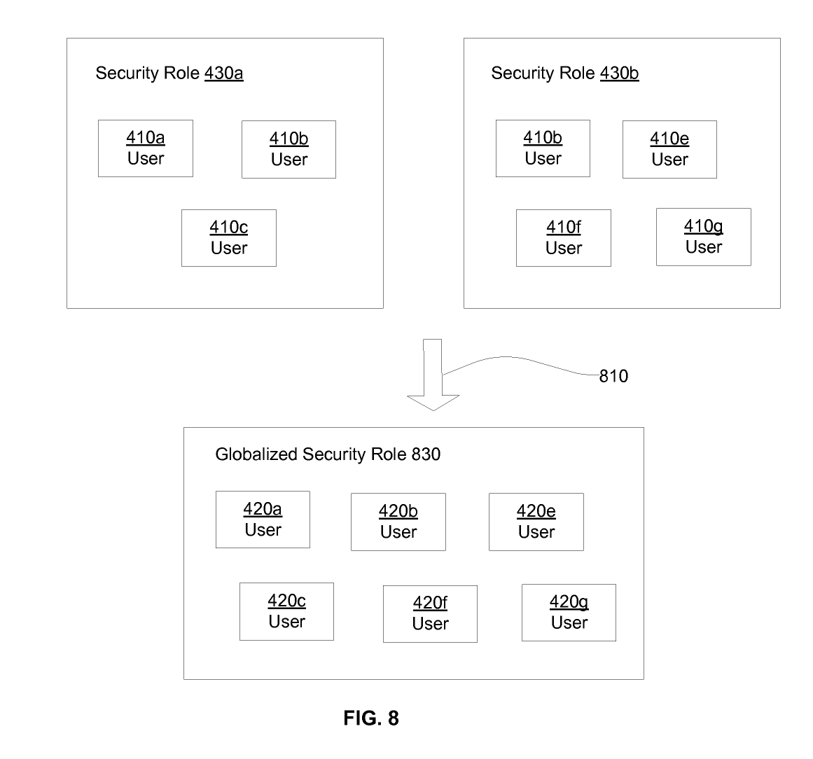

FIG. 8 illustrates merging of the security information by the federator 330 to generate globalized security information. The federator 330 matches security roles based on heuristics, for example, the names of the security roles 430 or metadata information provided with each security roles 430. In an embodiment, the federator 330 requests approval from a system administrator before combining security roles 430. As illustrated in FIG. 8, the security roles 430a and 430b are combined 810 by the federator 330 to create a globalized security role 830. The users 410 belonging to the security role 430 comprise the users belonging to the security roles 430a and 430b. In an embodiment, a system administrator is allowed to edit the globalized security role 830 by adding or deleting users 410 from the globalized security role 830.

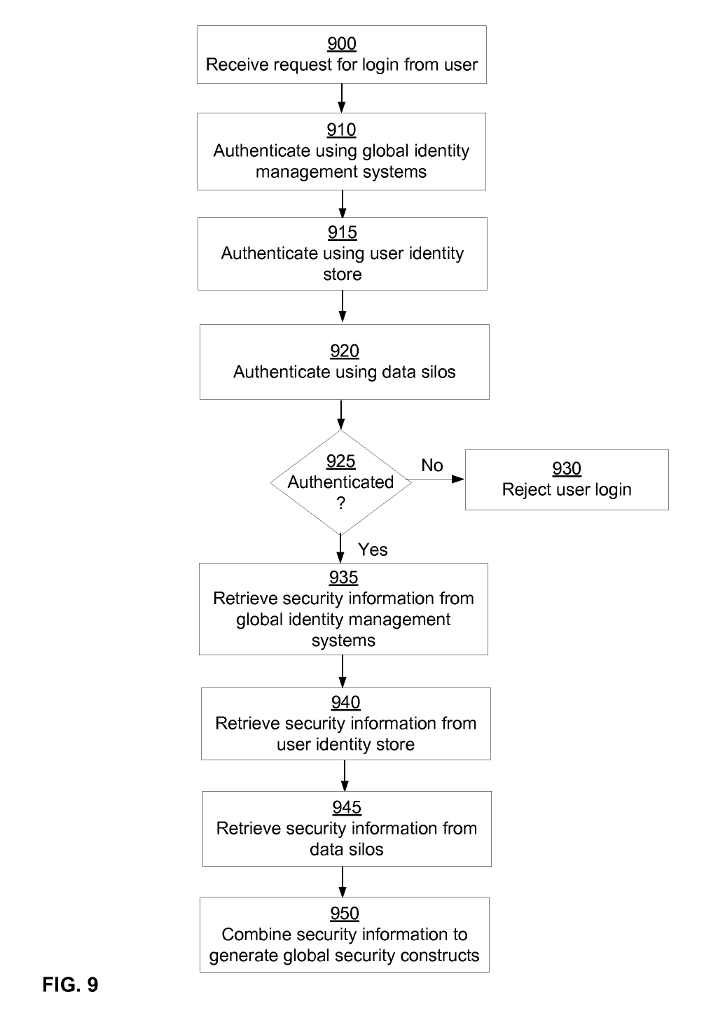

FIG. 9 shows a flowchart describing the process for enforcing security constraints for a user session that allows access to the enterprise information, for example, via search in accordance with an embodiment of the present invention. The web server 355 receives 900 a request to login to the data virtualization system 100 from a user. The request to login is also considered a request to create a session for receiving further requests. Based on information provided by the user, the web server 355 attempts to authenticate the user against a global identity management system 375. The web server 355 can also attempt to authenticate 915 the user against the user identity store 345. The web server 355 can also attempt to authenticate 920 the user against the data silos 150. If any authentication attempt succeeds 925, the user is allowed to login, or else the user login request is rejected 930. The order in which the steps of the flowchart shown in FIG. 9 are executed can be different, for example, attempts to authenticate against various sources can be executed in a different order. In an embodiment, anonymous searches are disabled and only searches by users authenticated by the data virtualization system 100 are allowed. In an embodiment, the data access APIs 180 include an authentication API for creation of custom login modules, for example, to support user authentication in external applications. A reason for enforcing authorization of every user requesting a session is to determine what kind of information the user is allowed to see.

If the authentication of the user request succeeds, a session is created for the user successfully. Subsequent requests for information can be received from the user session, for example, requests to search for information available across the data silos 150. The web server 355 retrieves 935, 940, 945 the latest security information from various sources, for example, the global identity management systems 375, from the user identity store 345, or directly from the data silos 150. The security information retrieved from the various sources is combined to generate global security constructs. For example, access control lists retrieved form various sources can be combined to generate global access control lists associated with entity types. In one embodiment, a union of access control lists associated with a global entity type is performed to generate a global access control list for the global entity type. Similarly security roles retrieved from various sources are combined to generate global security roles. In one embodiment, a union of two security roles considered equivalent can be performed to generate a global security role. Two security roles can be considered equivalent is they correspond to security of users with similar responsibility but may comprise different sets of users since they are retrieved from different data silos. For example, the security role defined for executive staff in a customer relationship management (CRM) system may have difference compared to the security role for executive staff defined in an email exchange system. By merging the two security roles, a global security role can be defined for the executive staff that applies across the data silos 150 corresponding to the CRM system and the email exchange system.

The security information that is retrieved for a user session is used for subsequent requests associated with a session. If the user disconnects from the session and creates a new session, the security information is refreshed again for the new session. Refreshing the information for the user for each session has the advantage of reflecting any real world changes in the enterprise in real-time, for example, an employee moving from one group to another or leaving the enterprise thereby changing the employee's security permissions stored in various data stores keeping the security information.

In some embodiments, the federator 330 updates global information periodically. In other embodiments, the federator 330 updates information in real-time as changes occur. The federator 330 renders the globalized information in the form of documents, for example, HTML and XML documents. The documents generated by the federator 330 can be fed in real-time to a search engine 160. The output of the federator 330 is a document for each entity instance that is indexed by the index engine 370. In some embodiments, the documents generated by the federator 330 are HTML documents. The document representing an entity instance contains the metadata or descriptor and value pairs of the information extracted from the source.

The federator 330 works in coordination with the spider 335. The spider 335 analyzes all the data silos to determine the information that has changed incrementally since the last iteration. The changed information is fed to the federator 330 for processing. The spider 335 schedule can be adjusted by an administrator to minimize its effect on the systems being processed by the spider 335. In practice, certain delays may occur due to various factors including slow processing speeds of computers or network delays but the changes can be considered to occur in real-time for practical purposes.

The search results are filtered by the access permissions of the user performing the search. For example, if a customer support representative searches for a particular customer name, the customer support representative is presented with business entities on top of the search results such as the customer's trouble tickets, knowledge base articles related to the customer's products and other business entities that relate to the customer representatives role. If the same search for a particular customer name is performed by an accounts payable specialist, the search results may display on top, an outstanding customer's invoice, contract agreement documents and other information relevant to the role of the user performing the search. If the customer service representative in the first example explicitly searches for the customer and invoice information, the data may not be presented at all in the search results due to access restrictions imposed on the searcher's role.

Entity instance scores are computed at real-time by the search engine 160 to determine the relevance of individual entity instances to the searcher in order to determine the order in which the search results are presented to the user. The search engine may use information stored in the metadata of the corresponding entity types to determine individual entity instance scores. The entity instance score is used to determine a document score for the document rendered 460 corresponding to the entity instance. The document score is used by the search engine to determine the relevance of search results, for example, a document with higher score is presented higher up in the order of search results compared to a document scored lower.

### Alternative Embodiments

It is to be understood that the Figures and descriptions of the present invention have been simplified to illustrate elements that are relevant for a clear understanding of the present invention, while eliminating, for the purpose of clarity, many other elements found in a typical system that allows users to view report data. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an integrated search across enterprise data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for managing security for searches across an enterprise comprising a plurality of data silos, the method comprising:
receiving a request for creating a session for retrieving information stored in a plurality of data silos, wherein the request is associated with a user;
responsive to receiving the request for creating the session, retrieving security information associated with the user from a data silo in the plurality of data silos;
receiving a search request associated with the session for searching information across the plurality of data silos;
retrieving a set of electronic documents matching the search request from a plurality of electronic documents, wherein electronic documents from the plurality of electronic documents represent instances of entity types in the data silos; and
returning a subset of the set of electronic documents, wherein the subset corresponds to documents representing entity types that the user is permitted to access based on the security information.

2. The computer implemented method of claim 1, wherein the plurality of data silos comprises a first data silo and a second data silo and the data in the first data silo is populated by a first application and the data in the second data silo is populated by a second application.

3. The computer implemented method of claim 1, wherein the security information determines whether a field of an entity type is accessible to the user.

4. The computer implemented method of claim 1, wherein the security information associated with an entity type includes an access control list that comprises a set of users that can access the entity type.

5. The computer implemented method of claim 1, wherein the security information comprises a security role comprising a set of users and a set of entity types that can be accessed by users belonging to the security role.

6. The computer implemented method of claim 1, wherein the security information comprises a fencing rule associated with a security role, wherein the fencing rule determines a subset of entity types accessible to users belonging to the security role.

7. The computer implemented method of claim 1, wherein the security information combines a first security information retrieved from a first data silo with a second security information retrieved from a second data silo.

8. The computer implemented method of claim 7, wherein the security information combines a first access control list associated with a first entity type retrieved from a first data silo with a second access control list associated with a second entity type retrieved from a second data silo, wherein the first entity type is combined with the second entity type.

9. The computer implemented method of claim 7, wherein the security information combines a first security role retrieved from a first data silo with a second security role retrieved from a second data silo, and the first security role and the second security role are combined into a global security role comprising users from the first security role and the second security role.

10. The computer implemented method of claim 1, wherein the security information combines first security information retrieved from a data silo with second security information from a global identity management system.

11. The computer implemented method of claim 1 further comprising:
authenticating the session based on security information retrieved from the data silo.

12. The computer implemented method of claim 1 further comprising:
authenticating the session based on security information retrieved from a global identity management system.

13. The computer implemented method of claim 1, wherein the search request is a first search request, the set of electronic documents is a first set of electronic documents, and the subset of electronic documents is a first subset of electronic documents, the method further comprising:
receiving a second search request associated with the session for searching information across the plurality of data silos;
retrieving a second set of electronic documents matching the search request from the plurality of electronic documents, wherein electronic documents from the plurality of electronic document represent instances of entity types in the data silos; and
returning a second subset of the second set of electronic documents, wherein the second subset corresponds to documents representing entity types that the user is permitted to access based on the security information.

14. The computer implemented method of claim 1, wherein a first electronic document in the plurality of electronic documents comprises a link to a second electronic document in the plurality of electronic documents, the first electronic document associated with a first entity type, the second electronic document associated with a second entity type, and the first and the second entity types having an entity type relationship.

15. The computer implemented method of claim 1, wherein the set of electronic documents comprises HTML documents and a relationship instance between a source entity instance and a target entity instance is represented by a hypertext link from a source HTML document corresponding to the source entity instance to a target HTML document corresponding to the target entity instance.

16. The computer implemented method of claim 1, wherein an electronic document in the plurality of electronic documents corresponds to a global entity type obtained by combining a first entity type from an first data silo and a second entity type from a second data silo.

17. The computer implemented method of claim 1, wherein electronic documents in the set of electronic documents are ranked based on scores representing the relevancy of each document for the user.

18. The computer implemented method of claim 1, wherein the security information is associated with modifications specified by a system administrator, the method further comprising:
applying the modifications to the security information retrieved from the data silo.

19. A system for searching across an enterprise comprising a plurality of data silos, the system comprising:
a computer processor; and
a computer-readable storage medium storing computer program modules configured to execute on the computer processor, the computer program modules comprising:
a web server configured to:
receive a request for creating a session for retrieving information stored in a plurality of data silos, wherein the request is associated with a user;
responsive to receiving the request for creating the session, retrieve security information associated with the user from a data silo in the plurality of data silos; and
a search engine configured to:
receive a search request associated with the session for searching information across the plurality of data silos;
retrieve a set of electronic documents matching the search request from a plurality of electronic documents, wherein electronic documents from the plurality of electronic documents represent instances of entity types in the data silos; and
return a subset of the set of electronic documents, wherein the subset corresponds to documents representing entity types that the user is permitted to access based on the security information.

20. A computer program product having a computer-readable storage medium storing computer-executable code for searching across an enterprise comprising a plurality of data silos, the code comprising:
a web server configured to:
receive a request for creating a session for retrieving information stored in a plurality of data silos, wherein the request is associated with a user;
responsive to receiving the request for creating the session, retrieve security information associated with the user from a data silo in the plurality of data silos; and
a search engine configured to:
receive a search request associated with the session for searching information across the plurality of data silos;
retrieve a set of electronic documents matching the search request from a plurality of electronic documents, wherein electronic documents from the plurality of electronic documents represent instances of entity types in the data silos; and
return a subset of the set of electronic documents, wherein the subset corresponds to documents representing entity types that the user is permitted to access based on the security information.
